(19) United States
(12) Patent Application Publication
(10) Pub. No.: US 2024/0331590 A1
(43) Pub. Date: Oct. 3, 2024

(54) COLOR PERCEPTION TUNING FOR A WEARABLE DEVICE IN VARIOUS LIGHT CONDITIONS

(71) Applicant: Meta Platforms Technologies, LLC, Menlo Park, CA (US)

(72) Inventors: Jiangtao Kuang, San Jose, CA (US); Jeanne Vu, Brea, CA (US); Gustav Braun, Santa Clara, CA (US); Ruidong Zhu, San Jose, CA (US); Hien Truong, Sunnyvale, CA (US); Jun Miao, San Jose, CA (US); Che Shen, Redmond, WA (US)

(21) Appl. No.: 18/444,719

(22) Filed: Feb. 18, 2024

Related U.S. Application Data
(60) Provisional application No. 63/492,890, filed on Mar. 29, 2023.

(51) Int. Cl. G09G 3/00

(52) U.S. Cl. CPC G09G 3/001; G09G 2320/0242; G09G 2320/0633; G09G 2320/0666

(57) ABSTRACT

Systems and methods for improving perceptual consistency of imaging data displayed on a wearable mobile device may include determining ambient light intensity in an operating environment of a mobile device. The systems and methods may include storing image data on the mobile device. The image data number of pixels, and each of the number of pixels includes color characteristics. The systems and methods may include adjusting the color characteristics of the image data based on the intensity level of the light. Adjusting the color characteristics may include applying a color perception model to the image data to generate adjusted image data. The color perception model is configured to adjust hue color characteristics and tone color characteristics of the image data. The systems and methods may include displaying the adjusted image data on a display of the mobile device.

### CROSS-REFERENCE TO RELATED APPLICATIONS

This application claims priority to U.S. provisional Application No. 63/492,890 filed Mar. 29, 2023, which is hereby incorporated by reference.

### TECHNICAL FIELD

This disclosure relates generally to mobile devices, and in particular to screen brightness adjustments of wearable mobile devices.

### BACKGROUND INFORMATION

Human visual systems respond to certain ambient light levels differently. For example, under high ambient light conditions, we only use cones to process light (photopic vision). By contrast, under pitch dark conditions without any artificial light, the eye uses rods to process light (scotopic vision). However, at a certain range of luminance levels (0.01-3.0 cd/m2), both cones and rods are active. This is called mesopic vision, which is a combination of photopic and scotopic vision. Color perception can be very different for people between photopic and mesopic vision. As a result, the same color (physically same) might be perceived differently at different ambient light levels. Keeping image appearance (e.g., color and contrast) consistent across different ambient light conditions for resource-restrained wearable mobile devices is a challenge.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 illustrates a block diagram of a mobile device configured to make color perception adjustments to image data, in accordance with aspects of the disclosure.

FIGS. 2A, 2B, 2C, and 2D illustrate example models and equations for applying a color perception model to image data, in accordance with aspects of the disclosure.

FIGS. 3A, 3B, 3C, and 3D illustrate flow diagrams of defining portions of a color perception model, in accordance with aspects of the disclosure.

FIGS. 4A, 4B, and 4C illustrate various CIE diagrams to show color shifting with a color perception model, in accordance with aspects of the disclosure.

FIG. 5 illustrates a block diagram illustrating an artificial reality system, in accordance with aspects of the disclosure.

FIG. 6 illustrates a block diagram illustrating a wearable device, in accordance with aspects of the disclosure.

FIG. 7 illustrates a block diagram illustrating a computer system, in accordance with aspects of the disclosure.

FIG. 8 illustrates a diagram of an example implementation of a wearable device configured to maintain consistent color perception over various ambient light intensities, in accordance with aspects of the disclosure.

FIG. 9 illustrates a diagram of an example implementation of a wearable device configured to maintain consistent color perception over various ambient light intensities, in accordance with aspects of the disclosure.

FIG. 10 illustrates a flow diagram of a process adjusting image data to maintain color perception of the image data over various ambient light intensities, in accordance with aspects of the disclosure.

### DETAILED DESCRIPTION

Embodiments of color perception tuning for a wearable device in various light conditions are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In some implementations of the disclosure, the term “near-eye” may be defined as including an element that is configured to be placed within 50 mm of an eye of a user while a near-eye device is being utilized. Therefore, a “near-eye optical element” or a “near-eye system” would include one or more elements configured to be placed within 50 mm of the eye of the user.

In aspects of this disclosure, visible light may be defined as having a wavelength range of approximately 380 nm-700 nm. Non-visible light may be defined as light having wavelengths that are outside the visible light range, such as ultraviolet light and infrared light. Infrared light having a wavelength range of approximately 700 nm-1 mm includes near-infrared light. In aspects of this disclosure, near-infrared light may be defined as having a wavelength range of approximately 700 nm-1.6 μm.

In aspects of this disclosure, the term “transparent” may be defined as having greater than 90% transmission of light. In some aspects, the term “transparent” may be defined as a material having greater than 90% transmission of visible light.

The disclosure addresses variations and/or inconsistencies in users' color perception of displays or screens in different lighting conditions. Small-sized displays, e.g., for a wearable smart watch or AR glasses, may be particularly susceptible to variation due to having less-powerful processors. The traditional approach to addressing changes in visibility of a screen in different lighting conditions is to adjust the brightness of the display, but this approach is does not address the underlying issues associated with changes to color perception in different lighting conditions due to the nature of the human eye.

In accordance with aspects of the disclosure, a mobile device is configured to apply a color perception model to image data to reduce perceptual inconsistencies in colors of image data across a range of ambient light levels. The mobile device can be a wearable smart watch, augmented reality (AR) glasses, or another relatively lightly powered mobile device. The mobile device receives image data and may apply the color perception model to the image data to generate adjusted image data. The mobile device displays the color perception adjusted image data on a display (e.g., a screen, a waveguide, etc.) of the mobile device. The image data may originate from a camera, from a (wireless) communications circuitry, or from memory (e.g., pre-loaded images, videos, UI elements), for example. The mobile device applies various aspects of the color perception model based on determined ambient light levels (e.g., the light level in the operating environment of the mobile device). The ambient light levels may be determined by analyzing the image data (if received from the camera) or from a light detection sensor of the mobile device, for example.

The mobile device may be configured to use a color perception model to improve perceptual consistency of colors in displayed image data across a range of ambient light levels. The color perception model may include a number of sub-models. The sub-models may include a hue model, a tone model, and a brightness model. The hue model may include an array of 3×3 matrices that have been trained or defined to reduce color perception inconsistencies for particular ranges of ambient light. Each 3×3 matrix in the array may be paired with a particular range of ambient light levels. The tone model and brightness models may also each have values that are paired with a particular range of ambient light levels. The color perception model may be implemented as a look up table that defines hue settings, tone settings, and brightness settings based on particular ranges of ambient light levels, in accordance with aspects of the disclosure.

The various color models may be trained using psychophysical data, for example, collected from a number of observers. Each of the models may be predictive or forward models that are generated using model generation algorithms and/or techniques. In one embodiment, the models are generated using algorithms configured to solve the inverse problem. For example, algorithms that apply a non-linear and iterative approach may be used. In one embodiment, a model generation algorithm such as fminsearch may be used to generate the models. The fminsearch algorithm can use the Nelder-Mead simplex algorithm and can use a simplex of n+1 points for n-dimensional vectors x. The algorithm first makes a simplex around an initial guess x0 by adding 5% of each component x0(i) to x0, and using these n vectors as elements of the simplex in addition to x0. Then, the algorithm modifies the simplex repeatedly according to the following procedure.

In one implementation, the models are generated using the pseudo-inverse method/technique. The pseudo-inverse method is a mathematical technique used to solve systems of linear equations, particularly when dealing with problems with non-invertible matrices. It can provide a solution even when there is not a unique or exact solution possible. When fitting a model to observed data, the pseudo-inverse can find the model parameters that minimize/reduce the discrepancy between the model predictions and the data. There are different definitions of the pseudo-inverse, and one example is the Moore-Penrose inverse. In general, the pseudo-inverse method: minimizes/reduces the squared error between the actual solution and the estimated solution; and provides the solution with the smallest norm (length) among all possible solutions.

The models can be loaded onto a wearable device, such as a smart watch or head-mounted device, and correct color and contrast in real-time based on the viewing conditions and brightness settings of the wearable. The color perception model may represent the delta between human perception of color under various lighting conditions and reference images. In various embodiments, the color model is compressed into a 3×3 matrix that can be implemented on hardware and computed efficiently. Once deployed, the color perception model can be continually updated as more reference images and corrected images become available.

In one embodiment, the 3×3 matrices are trained using synthetic data with hue shift to overcome some of the limitations of a 3×3 matrix, which has only 9 tunable elements, to match the performance of color 3D look up table (LUT), which usually has 17×17×17 elements. 3D LUT is good, but it can consume memory and can be computationally intensive to operate. By contrast a 3×3 matrix can more easily be run by smaller processors, such as that of a smart watch.

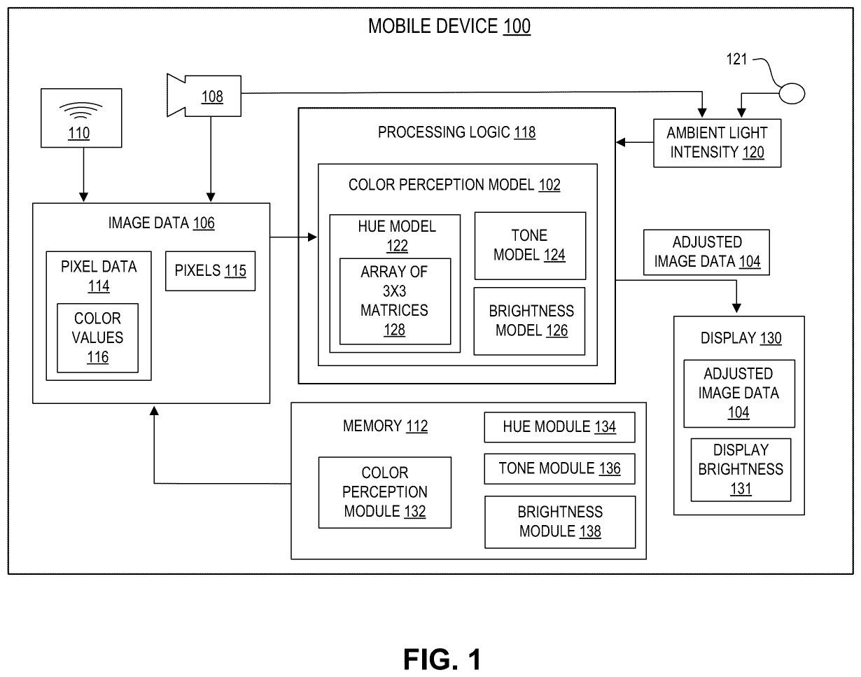

The apparatus, system, and method for color perception tuning for a wearable device in various light conditions that are described in this disclosure can provide improvements in the quality of user experiences with smart watches, head-mounted devices, and other mobile devices-leading to increased adoption. These and other embodiments are described in more detail in connection with FIGS. 1-10

FIG. 1 illustrates a diagram of a mobile device 100 that is configured to maintain color perception of image data across various ambient light intensities, in accordance with aspects of the disclosure. Mobile device 100 includes a color perception model 102 that is configured to generate adjusted image data 104 that has been color perception adjusted for a particular ambient light intensity, according to an embodiment. Color perception model 102 generates adjusted image data 104 by tuning or making adjustments to image data 106 that has been input into color perception model 102, according to an embodiment. Mobile device 100 may be implemented as a wearable electronic device (e.g., a smart watch), may be implemented as a head-mounted device (e.g., augmented reality glasses), and/or may be implemented as a handheld electronic device (e.g., a smartphone, tablet, etc.), according to various embodiments. A head-mounted device may be implemented as a wearable smart device or as a head-mounted display (HMD). The head-mounted device may be configured to provide artificial reality. Artificial reality is a form of reality that has been adjusted in some manner before presentation to the user, which may include, e.g., virtual reality (VR), augmented reality (AR), mixed reality (MR), hybrid reality, or some combination and/or derivative thereof.

Image data 106 may come from one or more of a variety of sources, in accordance with aspects of the disclosure. For example, image data 106 may be output from a camera 108 of mobile device 100. Camera 108 is representative of one or more camera modules that include an image sensor and that may be positioned in various locations on mobile device 100. The image sensor may be a complementary metal oxide (CMOS) image sensor, or the like. Image data 106 may be wirelessly received from a communications module 110, according to an embodiment. Communications module 110 may be configured to communicate using one or more of a variety of wireless communications protocols including, but not limited to, Wi-Fi, Bluetooth, and near field communications (NFC). Image data 106 may also represent images and/or videos stored on memory 112 (e.g., volatile and/or non-volatile), according to an embodiment. Image data 106 that is stored by or originating from memory 112 may be provided to mobile device 100 programmatically, with a memory card, using a wired connection, or using other data transfer technology, according to an embodiment. Image data 106 represents one or more images and/or one or more videos, according to an embodiment.

Image data 106 may include pixel data 114 that is data representative of one or more pixels 115, in accordance with aspects of the disclosure. Pixels 115 are arranged in hundreds or thousands of rows and columns in image data 106, and each pixel typically includes information about the color and brightness of a small portion of image data 106. Pixel data 114 may include data for each one of pixels 115. Pixel data 114 for each one of pixels 115 may include color values 116, according to an embodiment. Color values 116 may include a red color value, a green color value, and a blue color value (R, G, B) for each pixel of pixels 115. Pixel data 114 may include other color characteristics as well. For example, for each one of pixels 115, pixel data 114 may have color values 116, a hue value, a tone value, a luminance, and/or a chromaticity, according to an embodiment. One or more of these color characteristics may be tuned or modified by color perception model 102 to generate adjusted image data 104, according to an embodiment.

Color perception model 102 is configured to maintain color perception of image data across various ambient light intensities, according to an embodiment. Color perception model 102 may be implemented as an algorithm, one or more mathematical operations (e.g., matrix multiplication), and/or a look up table that may be executed by processing logic 118 to generate adjusted image data 104, according to an embodiment. In one embodiment, processing logic 118 receives an ambient light intensity 120 and applies ambient light intensity 120 to color perception model 102 to determine one or more settings or adjustments to make to image data 106, to generate adjusted image data 104, according to an embodiment. In one embodiment, ambient light intensity 120 is determined from image data 106 that is provided by camera 108. However, if image data 106 is received from communications module 110 and/or memory 112, mobile device 100 may read or determine ambient light intensity 120 using, for example, camera 108 and/or dedicated light sensor 121 (e.g., a photodetector), according to an embodiment.

Color perception model 102 may include a number of sub-models that are configured to adjust color characteristics of image data 106 and settings of a display 130 of mobile device 100, in accordance with aspects of the disclosure. Color characteristics may include hue, tone, and tint. Hue may be defined as the most basic aspect of color and may refer a pure, unadulterated form, such as red, yellow, blue, green, etc. Primary and secondary colors may be considered hues. Tone may be defined as a variation of a hue created by adding/removing gray. With a tone adjustment, the basic color family may remain the same, but the overall feel of the color becomes softer and/or less saturated. Tint may be defined as a variation of a hue that is created by adding/removing white instead of gray. Tints may be brighter and paler than the original hue.

Color perception model 102 may include a hue model 122, a tone model 124, and a brightness model 126, according to an embodiment. Hue model 122 may be configured to adjust hue characteristics of image data 106, according to an embodiment. Hue model 122 may include an array of 3×3 matrices 128 that are configured to tune or adjust color values 116 of pixel data 114 of image data 106, according to an embodiment. Color perception model 102 and hue model 122 may be configured to select one 3×3 matrix of the array of 3×3 matrices 128 to apply to image data 106 based on a particular value or range of values of ambient light intensity 120, according to an embodiment. For example, array of 3×3 matrices 128 may include seven different matrices with each matrix corresponding with a different value or range of values of ambient light intensity 120, according to an embodiment. Tone model 124 may include a multiplier or coefficient of a quantity of gray that is applied to (e.g., multiplied by) color values 116 to adjust the tone of image data 106 based on a value or a range of values of ambient light intensity 120. Brightness model 126 may include one or more display brightness settings 131 for display 130 that are associated with a value or range of values of ambient light intensity 120, and that support maintaining color perception of image data across various ambient light intensities, according to an embodiment.

Color perception model 102 and the corresponding sub-models may be stored as software modules in memory 112, according to an embodiment. Modules may be functional software components. Modules may be self-contained components having defined functions and interfaces. Modules may be or may include code segments that perform specific tasks within a software program (e.g., within color perception module 132). Color perception model 102 may be stored in memory 112 as color perception module 132. Hue model 122 may be stored in memory 112 as hue module 134. Tone model 124 may be stored in memory 112 as tone module 136. Brightness model 126 may be stored in memory 112 as brightness module 138, in accordance with aspects of the disclosure. One or more of the modules may be read and/or executed by processing logic 118 to perform one or more operations disclosed herein.

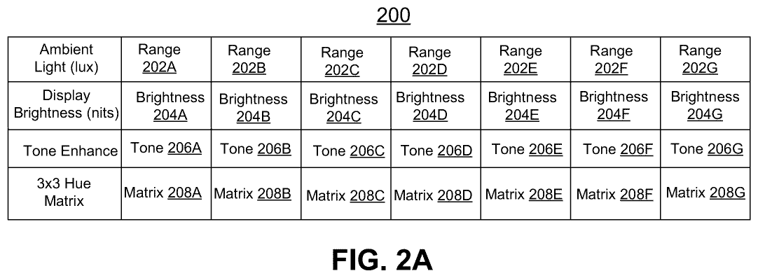

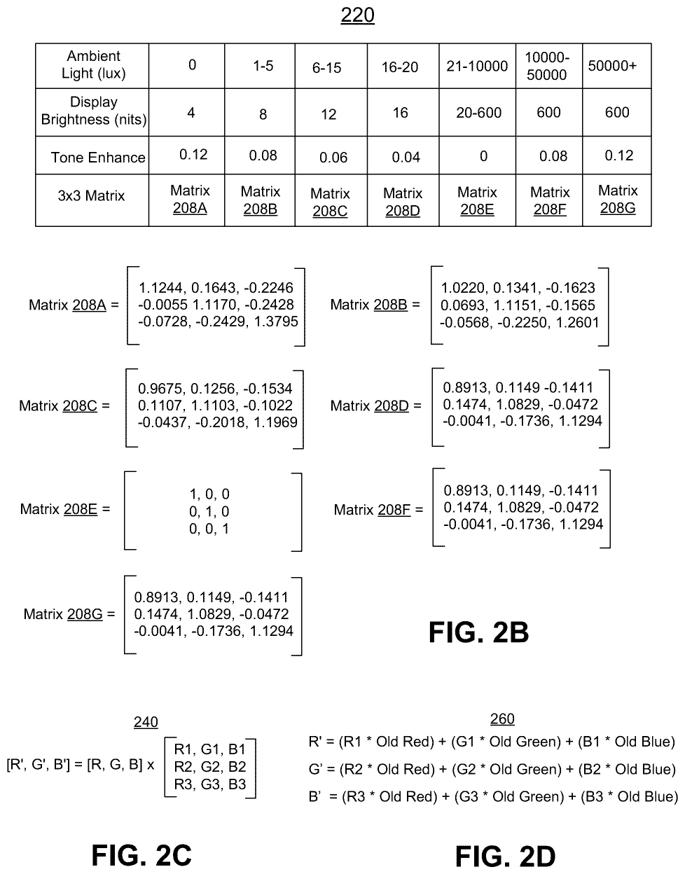

FIGS. 2A, 2B, 2C, and 2D illustrate examples of models that can be used to adjust image data for color perception across various ambient light conditions, in accordance with aspects of the disclosure. FIG. 2A illustrates a table 200 that may be an example implementation of color perception model 102 (shown in FIG. 1), according to an embodiment. Table 200 is a look up table, in an embodiment. Table 200 includes rows and columns of settings that may be applied to image data based on a value or range of values of ambient light. For example, for a range 202A of ambient light, table 200 may define: a brightness 204A for display brightness, a tone 206A for tone enhancement, and a matrix 208A for a 3×3 hue matrix. For each of the ranges of ambient light (e.g., range 202A-G), table 200 may define corresponding settings for: display brightness (e.g., brightness 204A-G), tone enhancement (e.g., tone 206A-G), and a 3×3 hue matrix (e.g., matrix 208A-G).

FIG. 2B illustrates a table 220 that includes examples of specific values that may be applied to image data to generate adjusted image data for maintaining color perception across various ambient light conditions, in accordance with aspects of the disclosure. The first row of table 220 includes example values and ranges of ambient light (in lux) that may be used as thresholds for applying the settings of subsequent rows of table 220. The second row of table 220 includes example values and ranges for display brightness (e.g., in nits) that may be applied based on a determined or measured ambient light value or range. For example, if the ambient light is 10 lux, a display brightness of 12 nits may be applied to a smart watch or display in AR glasses. The third row of table 220 includes example values and ranges for tone enhancements that may be applied based on a determined or measured ambient light value or range. The fourth row of table 220 includes examples of 3×3 hue matrices that may be applied to color values (e.g., RGB values for each pixel) based on a determined or measured ambient light value or range. Matrix E may be the identity matrix that tunes image data for a range of ambient light values that may be associated with indoor lighting and some outdoor lighting. Tone enhancements and hue adjustments may be the greatest at the extremities of light conditions (e.g., 0 lux and 50000+ lux), for example.

3×3 hue matrices include coefficients that are applied to RGB color values using matrix multiplication, according to an embodiment. The particular coefficients are trained, for example, using data from observers and by applying that data to a model generation algorithm, like the fminsearch algorithm or the pseudo-inverse method. In one embodiment, a baseline for a 3×3 hue matrix is the identity matrix of 1's and 0's (e.g., 3×3 hue matrix 208E), which might be paired with a tone enhancement of weight 0 (i.e., no change). Applying the identity matrix for a particular baseline setting is an example of tuning or adjusting image data for color perception consistency, according to an embodiment of the disclosure.

FIGS. 2C and 2D illustrate operations that may be performed to apply the 3×3 hue matrices to RGB color values (e.g., color values 116 of FIG. 1) to support generating adjusted image data (e.g., adjusted image data 104 of FIG. 1), according to an embodiment. FIG. 2C illustrates an example equation 240 of matrix multiplication of RGB values with a 3×3 matrix to generate new RGB values (illustrated as R′, G′, and B′). FIG. 2D illustrates an example of equations 260 that may be used to process a 1×3 matrix multiplied by a 3×3 matrix to generate a new 1×3 matrix of RGB values for a single pixel. These operations may be performed for the RGB values of each pixel with a mobile device processor, according to an embodiment.

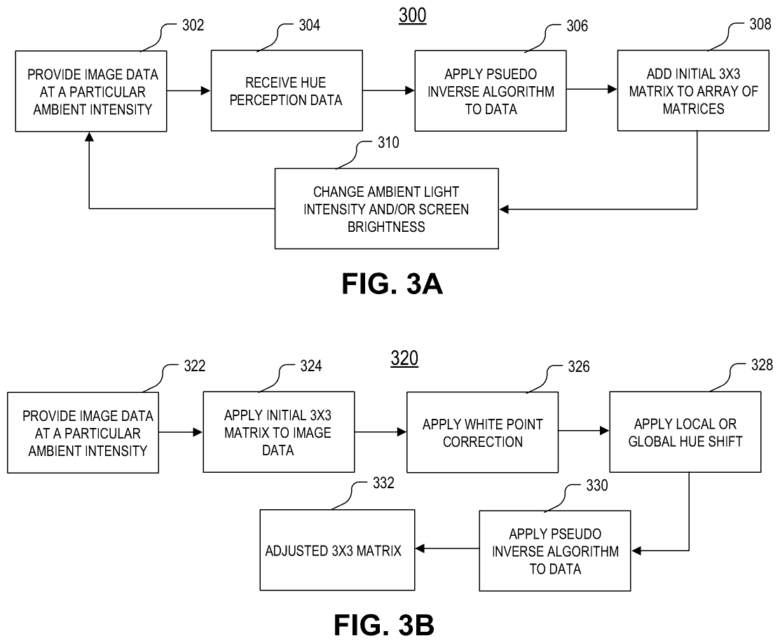

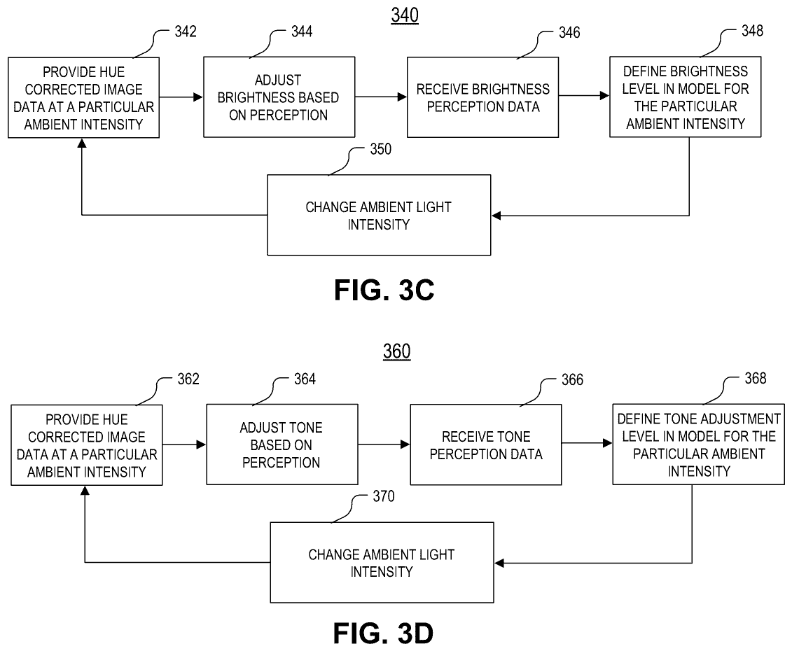

FIGS. 3A, 3B, 3C, and 3D illustrate diagrams of processes for training one or more models for tuning or modifying color characteristics or display settings to maintain color perception of image data across various ambient light intensities, in accordance with aspects of the disclosure.

FIG. 3A illustrates a flow diagram of a process 300 for generating initial 3×3 matrices, in accordance with aspects of the disclosure. The order in which some or all of the process blocks appear in process 300 should not be deemed limiting. Rather, one of ordinary skill in the art having the benefit of the present disclosure will understand that some of the process blocks may be executed in a variety of orders not illustrated, or even in parallel.

In process block 302, process 300 may include providing image data at a particular ambient light intensity, according to an embodiment. The image data may be provided to a group of observers in an A/B test experiment where one eye is exposed to a control version of the image at a control ambient light intensity, and the other eye is exposed to a test version of the image at various low-light and bright light ambient light intensities.

In process block 304, process 300 may include receiving hue perception data, according to an embodiment. The hue perception data may include a number of manual adjustments made by the observers at with the test version of the image until the hue of the control and test images nearly match, according to an embodiment. The adjustments can include adjusting the color (e.g., along three dimensions: luminance (L), chromaticity (C), hue (h)) to cause the test image to match the control images, and the adjustments may be made over several repetitions.

In process block 306, process 300 may include applying a pseudo-inverse algorithm to the data to generate a 3×3 matrix, according to an embodiment. Other model generation algorithms may also be used, e.g., fminsearch algorithm. The 3×3 matrix may be referred to as a forward model, which uses a known set of inputs or initial conditions and computes expected outputs or outcomes (e.g., hue adjusted image data). The pseudo-inverse algorithm converts the various perception data into a matrix form that may be applied to individual RGB values of image data, according to an embodiment.

In process block 308, process 300 may include adding the initial 3×3 matrix to an array of matrices for use in a color perception model, according to an embodiment.

In process block 310, process 300 may include changing ambient light intensity and/or screen brightness to acquire different perception data and to generate additional 3×3 matrices for the array of matrices, according to an embodiment.

FIG. 3B illustrates a flow diagram of a process 320 for refining 3×3 matrices of an array of 3×3 matrices for hue adjustment, in accordance with aspects of the disclosure. The order in which some or all of the process blocks appear in process 320 should not be deemed limiting. Rather, one of ordinary skill in the art having the benefit of the present disclosure will understand that some of the process blocks may be executed in a variety of orders not illustrated, or even in parallel.

In process block 322, process 320 may include providing image data at a particular ambient light intensity, according to an embodiment.

In process block 324, process 320 may include applying an initial 3×3 matrix (e.g., from process 300) to the image data, according to an embodiment.

In process block 326, process 320 may include applying white point correction to the adjusted image data, according to an embodiment. The initial 3×3 matrix (without correction) may have a white point that has shifted towards a greenish hue, which may be observable by observers. White point correction may include non-linear optimization techniques, for example.

In process block 328, process 320 may include applying local or global hue shift to the image data, according to an embodiment. The hue shift may include using 4913 (17×17×17) colors and using, for example, machine learning to train the 3×3 matrices.

In process block 330, process 320 may include applying the pseudo-inverse algorithm to the hue shifted image data to build a hue shifted model (e.g., adjusted 3×3 matrix 332) that also accounts for white point correction, according to an embodiment. Other forward model generation techniques may be used instead of the pseudo-inverse algorithm, according to an embodiment. For example, algorithms that apply a non-linear and iterative approach may be used, e.g., the fminsearch algorithm.

FIG. 3C illustrates a flow diagram of a process 340 for building a brightness model for color perception adaptation across various ambient light intensities, in accordance with aspects of the disclosure. The order in which some or all of the process blocks appear in process 340 should not be deemed limiting. Rather, one of ordinary skill in the art having the benefit of the present disclosure will understand that some of the process blocks may be executed in a variety of orders not illustrated, or even in parallel.

In process block 342, process 340 may include providing hue corrected image data at a particular ambient light intensity, according to an embodiment. The image data may be provided to a group of observers in an A/B test experiment where one eye is exposed to a control version of the image at a control ambient light intensity, and the other eye is exposed to a test version of the image at various low-light and bright light ambient light intensities.

In process block 344, process 340 may include adjusting brightness settings based on observers' perceptions of differences between control and test images, according to an embodiment.

In process block 346, process 340 may include receiving brightness perception data from a number of observers, according to an embodiment.

In process block 348, process 340 may include defining the brightness level in a brightness model for the particular ambient light intensity based on the received perception data, according to an embodiment.

In process block 350, process 340 may include changing ambient light intensity to acquire different perception data, according to an embodiment.

FIG. 3D illustrates a flow diagram of a process 360 for defining a tone model for adjusting image data to maintain consistent color perception, in accordance with aspects of the disclosure. The order in which some or all of the process blocks appear in process 360 should not be deemed limiting. Rather, one of ordinary skill in the art having the benefit of the present disclosure will understand that some of the process blocks may be executed in a variety of orders not illustrated, or even in parallel.

In process block 362, process 360 may include providing hue corrected image data at a particular ambient light intensity, according to an embodiment.

In process block 364, process 360 may include adjusting tone settings based on observers' perceptions of differences between control and test images, according to an embodiment.

In process block 366, process 360 may include receiving tone perception data from a number of observers, according to an embodiment.

In process block 368, process 360 may include defining the tone adjustment level in a tone model for the particular ambient light intensity based on the received perception data, according to an embodiment.

In process block 370, process 360 may include changing ambient light intensity to acquire different perception data, according to an embodiment.

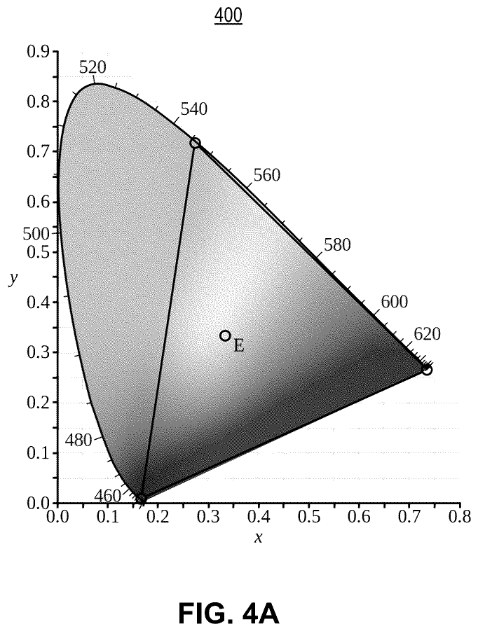

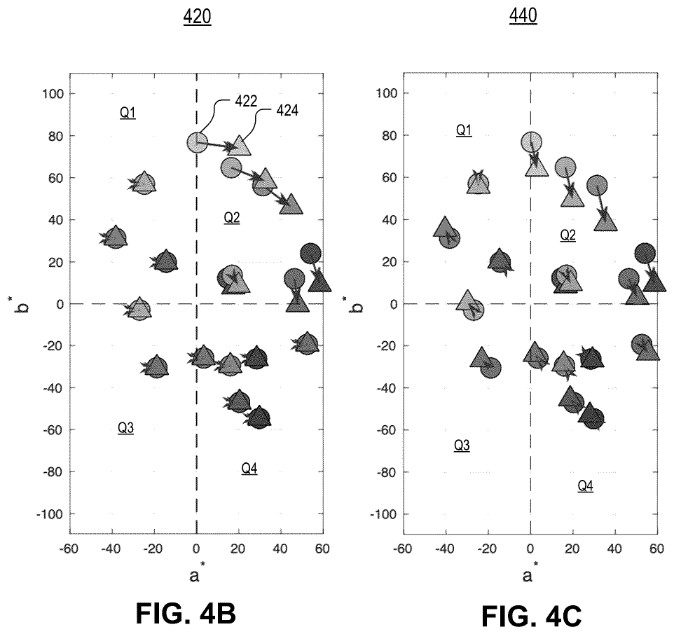

FIGS. 4A, 4B, and 4C illustrate CIE diagrams showing color shifts that may be performed by applying one or more color models (e.g., 3×3 hue matrices) disclosed herein, according to embodiments of the disclosure. FIG. 4A illustrates a diagram 400 that is a standard CIE chromaticity diagram. The CIE chromaticity diagram, also known as the CIE 1931 XYZ color space, is a graphical representation of all the colors humans can perceive. It is a horseshoe-shaped curve with various points and lines defining different aspects of color, including: an outer curve that represents monochromatic colors at a specific wavelength; an inner area that represents mixed colors created by mixing monochromatic colors; and a white point (E) representing a reference white point. Diagram 400 includes wavelength numbers in nanometers around a perimeter, including 460 nm (deep blue), 480 nm (lighter shade of blue), 500 nm (cyan or greenish-blue), 520 nm (green), 540 nm (yellower shade of green), 560 nm (green-yellowish), 580 nm (yellow), and 600 nm (orange or reddish-orange).

FIG. 4B illustrates a (CIE) diagram 420 that shows an ideal shift of colors when processed with a color perception model. In diagram 420 circles 422 represent unshifted positions of colors of an image and triangles 424 represent shifted positions of colors of an image. In diagram 420, a first quadrant Q1, a third quadrant Q3, and a fourth quadrant Q4 remain relatively unshifted, while the colors of a second quadrant Q2 are shifted for hue adjustment to maintain color perception. FIG. 4C illustrates a (CIE) diagram 440 that shows a shift of colors that may result after processing image data with a color perception model of the present disclosure, according to an embodiment. Diagram 440 also shows that quadrants Q1, Q3, and Q4 remain relatively unshifted, while the colors of second quadrant Q2 are shifted.

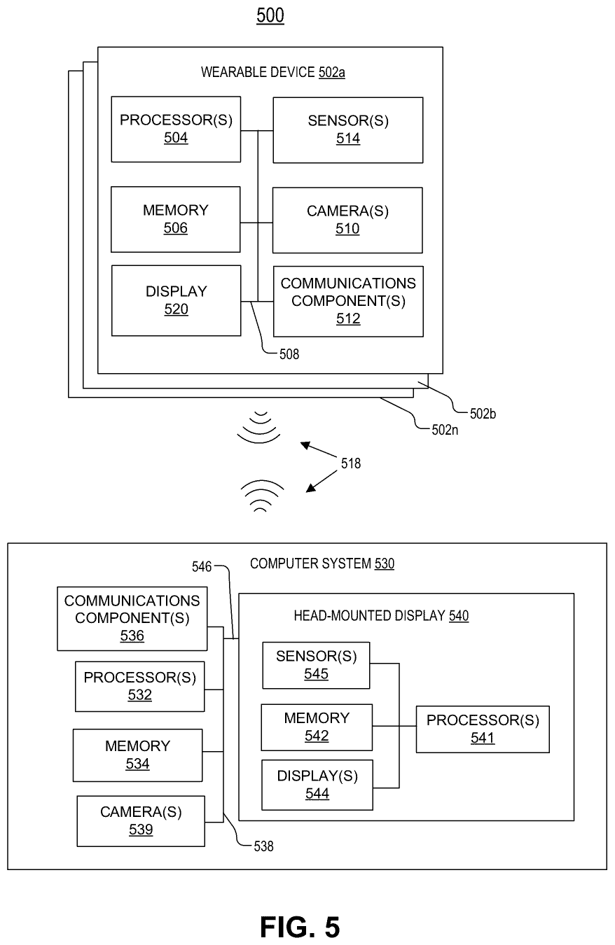

FIG. 5 is a block diagram illustrating a system 500, in accordance with various embodiments. While some example features are illustrated, various other features have not been illustrated for the sake of brevity and so as not to obscure pertinent aspects of the example embodiments disclosed herein. To that end, as a non-limiting example, the system 500 includes one or more wearable devices 502 (e.g., the devices 502 a, 502 b, . . . , 502 n), which are used in conjunction with a computer system 530 (e.g., a host system or a host computer). In some embodiments, the system 500 provides the functionality of a virtual reality device with haptics feedback, an augmented reality device with haptics feedback, a combination thereof, or provides some other functionality.

An example wearable device 502 (e.g., the wearable device 502 a) includes, for example, one or more processors/cores 504 (referred to henceforth as “processors”), memory 506, one or more cameras 510, one or more communications components 512, one or more sensors 514, and/or a display 520. In some embodiments, these components are interconnected by way of a communications bus 508. References to these components of the wearable device 502 cover embodiments in which one or more of these components (and combinations thereof) are included. In some embodiments, the one or more sensors 514 are part of the one or more cameras 510.

In some embodiments, a single processor 504 (e.g., the processor 504 of a first wearable device 502 a) executes software modules for controlling multiple wearable devices 502 (e.g., all of the wearable devices 502 a, 502 b, . . . , 502 n). In some embodiments, a single wearable device 502 (e.g., the wearable device 502 a) includes multiple processors 504, one or more communications component processors (e.g., configured to control communications transmitted by the communications component 512 and/or receive communications by way of the communications component 512) and/or one or more sensor processors (e.g., configured to control operation of the sensors 514 and/or receive output from the sensors 514).

The computer system 530 is a computing device that may execute virtual reality applications and/or augmented reality applications to process input data from the sensors 545 on the head-mounted display 540 and the sensors 514 on the wearable device 502. The computer system 530 provides output data for (i) the electronic display 544 on the head-mounted display 540 and (ii) the wearable device 502. In some embodiments, the computer system 530 includes one or more processors/cores 532, memory 534, one or more communications components 536, and/or one or more cameras 539. In some embodiments, these components are interconnected by way of a communications bus 538. References to these components of the computer system 530 cover embodiments in which one or more of these components (and combinations thereof) are included.

In some embodiments, the computer system 530 is a standalone device that is coupled to a head-mounted display 540. For example, the computer system 530 has processors/cores 532 for controlling one or more functions of the computer system 530 and the head-mounted display 540 has processors/cores 541 for controlling one or more functions of the head-mounted display 540. Alternatively, in some embodiments, the head-mounted display 540 is a component of computer system 530. For example, the processors 532 may control functions of the computer system 530 and the head-mounted display 540. In addition, in some embodiments, the head-mounted display 540 includes one or more processors 541, which communicate with the processors 532 of the computer system 530. In some embodiments, communications between the computer system 530 and the head-mounted display 540 occur via a wired connection between the communications bus 538 and the communications bus 546. In some embodiments, the computer system 530 and the head-mounted display 540 share a single communications bus. In some instances, the head-mounted display 540 is separate from the computer system 530 (not shown).

The computer system 530 may be any suitable computer device, such as a laptop computer, a tablet device, a netbook computer, a personal digital assistant, a mobile phone, a smart phone, a virtual reality device (e.g., a virtual reality (VR) device, an augmented reality (AR) device, or the like), a gaming device, a computer server, or any other computing device. The computer system 530 is sometimes called a host or a host system. In some embodiments, the computer system 530 includes other user interface components such as a keyboard, a touch-screen display, a mouse, a trackpad, and/or supplemental I/O devices to add functionality to the computer system 530.

In some embodiments, the one or more cameras 539 of the computer system 530 are used to facilitate virtual reality and/or augmented reality. Moreover, in some embodiments, the one or more cameras 539 also act as projectors to display the virtual and/or augmented images. In some embodiments, the computer system 530 includes one or more distinct projectors. In some embodiments, the computer system 530 provides images captured by the one or more cameras 539 to the display 544 of the head-mounted display 540, and the display 544 in turn displays the provided images. In some embodiments, the processors 541 of the head-mounted display 540 process the provided images. In some embodiments the one or more cameras 539 are part of the head-mounted display 540.

The head-mounted display 540 presents media to a user. Examples of media presented by the head-mounted display 540 include images, video, audio, or some combination thereof. In some embodiments, audio is presented via an external device (e.g., speakers and/or headphones) that receives audio information from the head-mounted display 540, the computer system 530, or both, and presents audio data based on the audio information. In some embodiments, the head-mounted display 540 includes one or more processors/cores 541, memory 542, and/or one or more displays 544. In some embodiments, these components are interconnected by way of a communications bus 546. References to these components of the head-mounted display 540 cover embodiments in which one or more of these components (and combinations thereof) are included. In some embodiments the head-mounted display 540 includes one or more sensors 545. Alternatively, in some embodiments, the one or more sensors 545 are part of the host system 530.

The electronic display 544 displays images to the user in accordance with data received from the computer system 530. In various embodiments, the electronic display 544 comprises a single electronic display or multiple electronic displays (e.g., one display for each eye of a user). The displayed images may be in virtual reality, augmented reality, or mixed reality.

The optional sensors 545 include one or more hardware devices that detect spatial and motion information about the head-mounted display 540. Spatial and motion information can include information about the position, orientation, velocity, rotation, and acceleration of the head-mounted display 540. For example, the sensors 545 may include one or more inertial measurement units (IMUs) that detect rotation of the user's head while the user is wearing the head-mounted display 540. This rotation information can then be used (e.g., by the computer system 530) to adjust the images displayed on the electronic display 544. In some embodiments, each IMU includes one or more gyroscopes, accelerometers, and/or magnetometers to collect the spatial and motion information. In some embodiments, the sensors 545 include one or more cameras positioned on the head-mounted display 540.

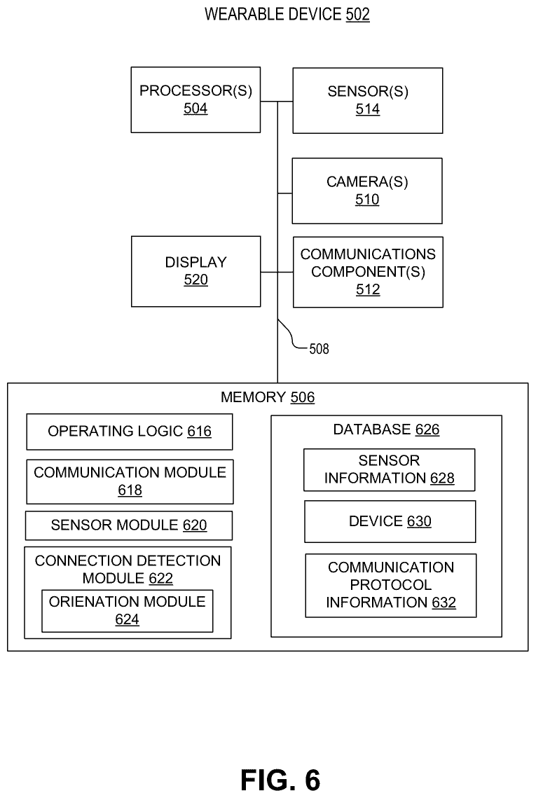

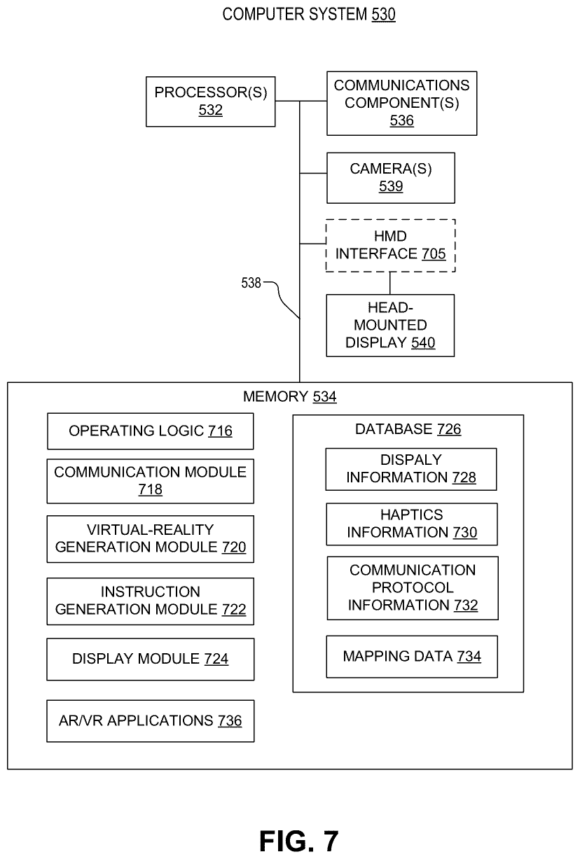

The communications component 512 of the wearable device 502 includes a communications component antenna for communicating with the computer system 530. Moreover, the communications component 536 of the computer system include a complementary communications component antenna that communicates with the communications component 512 of the wearable device. The respective communication components are discussed in further detail below with reference to FIGS. 6 and 7.

In some embodiments, data contained within communication signals 518 is used by the wearable device 502 for selecting values for characteristics used by the cameras 510 to instruct the user to adjust a camera on the display of the wearable device. For example, the wearable device receives an instruction from computer system 530 to capture a video stream from a wide-angle lens. The wearable device may display a graphical user interface instructing the user to rotate the display to position the correct camera in the correct orientation (e.g., rotate the display clockwise 90 degrees). In some embodiments, the data contained within the communication signals 518 alerts the computer system 530 that the wearable device 502 is ready for use.

Non-limiting examples of the sensors 514 and the sensors 545 include infrared sensors, pyroelectric sensors, ultrasonic sensors, laser sensors, optical sensors, Doppler sensors, gyro sensors, accelerometers, resonant LC sensors, capacitive sensors, heart rate sensors, acoustic sensors, and inductive sensors. In some embodiments, the sensors 514 and/or the sensors 545 are configured to gather data that is used to determine the hand posture of a user of the wearable device and/or an impedance of the medium. Examples of sensor data output by these sensors include: body temperature data, infrared range-finder data, motion data, activity recognition data, silhouette detection and recognition data, gesture data, heart rate data, and other wearable device data (e.g., biometric readings and output, and accelerometer data).

FIG. 6 is a block diagram illustrating a representative wearable device 502 in accordance with some embodiments. In some embodiments, the wearable device 502 includes one or more processing units 504 (e.g., CPUs, microprocessors, and the like), one or more communication components 512, memory 506, one or more cameras 510, and one or more communication buses 508 for interconnecting these components (sometimes called a chipset). In some embodiments, the wearable device 502 includes one or more sensors 514 as described above with reference to FIG. 5. In some embodiments (not shown), the wearable device 502 includes one or more output devices such as one or more indicator lights, a sound card, a speaker, or a small display for displaying textual information and error codes.

The communication components 512 enable communication between the wearable device 502 and one or more communication networks. In some embodiments, the communication components 512 include hardware capable of data communications using any of a variety of wireless protocols (e.g., IEEE 802.15.4, Wi-Fi, ZigBee, 6LoWPAN, Thread, Z-Wave, Bluetooth Smart, ISA100.11a, WirelessHART, or MiWi) wired protocols (e.g., Ethernet or HomePlug), and/or any other suitable communication protocol.

The memory 506 includes high-speed random access memory, such as DRAM, SRAM, DDR SRAM, or other random access solid state memory devices. In some embodiments, the memory includes non-volatile memory, such as one or more magnetic disk storage devices, one or more optical disk storage devices, one or more flash memory devices, or one or more other non-volatile solid state storage devices. The memory 506, or alternatively the non-volatile memory within memory 506, includes a non-transitory computer-readable storage medium. In some embodiments, the memory 506, or the non-transitory computer-readable storage medium of the memory 506, stores the following programs, modules, and data structures, or a subset or superset thereof: operating logic 616, including procedures for handling various basic system services and for performing hardware dependent tasks, a communication module 618, which communicates with remote devices (e.g., a computer system 530 or other wearable devices) in conjunction with communication components 512; and a sensor module 620, which obtains and processes sensor data (e.g., in conjunction with the sensors 514 and/or the cameras 510). The sensor module can determine the orientation of the wearable device 502 or determine the environmental conditions of the user of the wearable device. A connection detection module 622 can identify which of the multiple interchangeable displays is attached to the base of the wearable device. In some embodiments, the connection detection module 622 also includes an orientation module 624, which identifies the orientation of the attached display with respect to the base, and a database 626, which stores: sensor information 628 received, detected, and/or transmitted by one or more sensors 514, one or more remote sensors, and/or cameras; device settings 630 for the wearable device 502 and/or one or more remote devices (e.g., selected preferred orientations for the cameras); and communication protocol information 632 for one or more protocols (e.g., custom or standard wireless protocols, such as ZigBee or Z-Wave, and/or custom or standard wired protocols, such as Ethernet).

In some embodiments (not shown), the wearable device 502 includes a location detection device, such as a GNSS (e.g., GPS or GLONASS) or other geo-location receiver, for determining the location of the wearable device 502. In some embodiments, the wearable device 502 includes a location detection module (e.g., a GPS, Wi-Fi, magnetic, or hybrid positioning module) for determining the location of the wearable device 502 (e.g., using the location detection device) and providing this location information to the host system 530.

In some embodiments (not shown), the wearable device 502 includes a unique identifier stored in the database 626. In some embodiments, the wearable device 502 sends the unique identifier to the host system 530 to identify itself to the host system 530. This is particularly useful when multiple wearable devices are being used concurrently.

In some embodiments, the wearable device 502 includes one or more inertial measurement units (IMU) for detecting motion and/or a change in orientation of the wearable device 502. In some embodiments, the detected motion and/or orientation of the wearable device 502 (e.g., the motion/change in orientation corresponding to movement of the user's hand) is used to manipulate an interface (or content within the interface) displayed by the head-mounted display 540. In some embodiments, the IMU includes one or more gyroscopes, accelerometers, and/or magnetometers to collect IMU data. In some embodiments, the IMU measures motion and/or a change in orientation for multiple axes (e.g., three axes or six axes). In such instances, the IMU may include one or more instruments for each of the multiple axes. The one or more IMUs may be part of the one or more sensors 514.

Each of the above-identified elements (e.g., modules stored in memory 506 of the wearable device 502) can be stored in one or more of the previously mentioned memory devices and corresponds to a set of instructions for performing the functions described above. The above identified modules or programs (e.g., sets of instructions) need not be implemented as separate software programs, procedures, or modules, and thus various subsets of these modules can be combined or otherwise rearranged in various embodiments. In some embodiments, the memory 506 stores a subset of the modules and data structures identified above. In some embodiments, the memory 506 stores additional modules and data structures not described above.

FIG. 7 is a block diagram illustrating a representative computer system 530 in accordance with some embodiments. In some embodiments, the computer system 530 includes one or more processing units/cores 532 (e.g., CPUs, GPUs, microprocessors, and the like), one or more communication components 536, memory 534, one or more cameras 539, and one or more communication buses 538 for interconnecting these components (sometimes called a chipset). In some embodiments, the computer system 530 includes a head-mounted display interface 705 for connecting the computer system 530 with the head-mounted display 540. As discussed above in FIG. 5, in some embodiments, the computer system 530 and the head-mounted display 540 are together in a single device, whereas in other embodiments the computer system 530 and the head-mounted display 540 are separate from one another.

Although not shown in FIG. 7, in some embodiments, the computer system (and/or the head-mounted display 540) includes one or more sensors 545 (as discussed above with reference to FIG. 5).

The communication components 536 enable communication between the computer system 530 and one or more communication networks. In some embodiments, the communication components 536 include hardware capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol.

The memory 534 includes high-speed random access memory, such as DRAM, SRAM, DDR SRAM, or other random access solid state memory devices. In some embodiments, the memory includes non-volatile memory, such as one or more magnetic disk storage devices, one or more optical disk storage devices, one or more flash memory devices, or one or more other non-volatile solid state storage devices. The memory 534, or alternatively the non-volatile memory within memory 534, includes a non-transitory computer-readable storage medium. In some embodiments, the memory 534, or the non-transitory computer-readable storage medium of the memory 534, stores the following programs, modules, and data structures, or a subset or superset thereof: operating logic 716, including procedures for handling various basic system services and for performing hardware dependent tasks; a communication module 718, which communicates with remote devices (e.g., the wearable devices 502 a, . . . , 502-n, or a remote server (not shown)) in conjunction with communication components 536; and a virtual-reality generation module 720, which is used for generating virtual-reality images and sending corresponding video and audio data to the HMD 540. In some embodiments, the virtual-reality generation module 720 is an augmented-reality generation module (or the memory 534 includes a distinct augmented-reality generation module), which is used for generating augmented-reality images and projecting those images in conjunction with the cameras 539 and the HMD 540); an instruction generation module 722, which is used for generating an instruction that, when sent to the wearable device 502 (e.g., using the communications component 536), causes the wearable device 502 to instruct the user to adjust a display orientation (e.g., rotate the display to use a different camera) and/or interchange the entire display; a display module 724, which displays virtual-reality images and/or augmented-reality images in conjunction with the head-mounted display 540 and/or the cameras 539; and a database 726, which stores: display information 728, including virtual-reality images and/or augmented-reality images (e.g., visual data); haptics information 730, corresponding to the stored virtual-reality images and/or augmented-reality images; communication protocol information 732 for one or more protocols (e.g., custom or standard wireless protocols, such as ZigBee or Z-Wave, and/or custom or standard wired protocols, such as Ethernet); and mapping data 734, including geographic maps.

In the example shown in FIG. 7, the computer system 530 further includes virtual-reality (and/or augmented-reality) applications 736. In some embodiments, the virtual-reality applications 736 are implemented as software modules that are stored on the storage device and executed by the processor. Each virtual-reality application 736 is a group of instructions that, when executed by a processor, generates virtual reality content for presentation to the user. A virtual-reality application 736 may generate virtual-reality content in response to inputs received from the user via movement of the head-mounted display 540 or the wearable device 502. Examples of virtual-reality applications 736 include gaming applications, conferencing applications, and video playback applications.

The virtual-reality generation module 720 is a software module that allows virtual-reality applications 736 to operate in conjunction with the head-mounted display 540 and the wearable device 502. The virtual-reality generation module 720 may receive information from the sensors 545 on the head-mounted display 540 and may, in turn provide the information to a virtual-reality application 736. Based on the received information, the virtual-reality generation module 720 determines media content to provide to the head-mounted display 540 for presentation to the user via the electronic display 544. For example, if the virtual-reality generation module 720 receives information from the sensors 545 on the head-mounted display 540 indicating that the user has looked to the left, the virtual-reality generation module 720 generates content for the head-mounted display 540 that mirrors the user's movement in a virtual environment.

Similarly, in some embodiments, the virtual-reality generation module 720 receives information from the sensors 514 on the wearable device 502 and provides the information to a virtual-reality application 736. The application 736 can use the information to perform an action within the virtual world of the application 736. For example, if the virtual-reality generation module 720 receives information from the sensors 514 and/or cameras 510, 539 that the user has raised his or her hand, a simulated hand (e.g., the user's avatar) in the virtual-reality application 736 lifts to a corresponding height. As noted above, the information received by the virtual-reality generation module 720 can also include information from the head-mounted display 540. For example, the cameras 539 on the head-mounted display 540 may capture movements of the user (e.g., movement of the user's arm), and the application 736 can use this additional information to perform the action within the virtual world of the application 736.

To further illustrate with an augmented reality example, if the augmented-reality generation module 720 receives information from the sensors 514, the cameras 510, and/or the cameras 539, the content in the head-mounted display updates accordingly. When the information indicates that the user has rotated his or her forearm while a user interface (e.g., a keypad) is displayed on the user's forearm, the augmented-reality generation module 720 generates content for the head-mounted display 540 that mirrors the user's movement in the augmented environment (e.g., the user interface rotates in accordance with the rotation of the user's forearm).

Each of the above identified elements (e.g., the modules stored in the memory 534 of the computer system 530) can be stored in one or more of the previously mentioned memory devices, and corresponds to a set of instructions for performing the function(s) described above. The above identified modules or programs (e.g., sets of instructions) need not be implemented as separate software programs, procedures, or modules, and thus various subsets of these modules can be combined or otherwise rearranged in various embodiments. In some embodiments, the memory 534 stores a subset of the modules and data structures identified above.

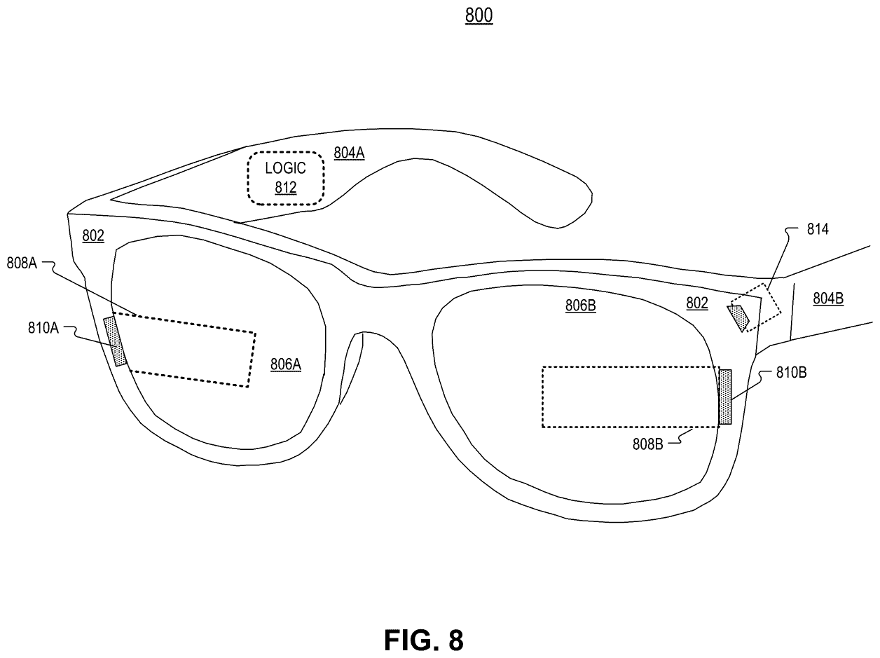

FIG. 8 illustrates a diagram of a head-mounted device 800 as an example of a wearable device that may be configured to use a color perception model to maintain consistency of color perception of an image over a range of ambient light intensities, in accordance with aspects of the disclosure. Head-mounted device 800 may include a frame 802, arms 804A and 804B (e.g., for supporting frame 802 along the side of the head of a user), and lenses 806A and 806B. Lens 806A may include an integrated display 808A (e.g., a waveguide) that is coupled to a projector 810A. Lens 806B may include an integrated display 808B that is optically coupled to a projector 810B. Head-mounted device 800 may include processing logic 812 that is coupled to projectors 810A and 810B and is configured to provide image data for display on displays 808A and/808B. Processing logic 812 may be configured to apply a color perception model (e.g., color perception model 102 of FIG. 1) to image data to maintain consistency of color perception for image data displayed (e.g., with display 808A/808B) over a variety of ambient light intensities, according to an embodiment. Head-mounted device 800 may include a camera 814 that captures ambient light intensity data and provides the ambient light intensity data to processing logic 812.

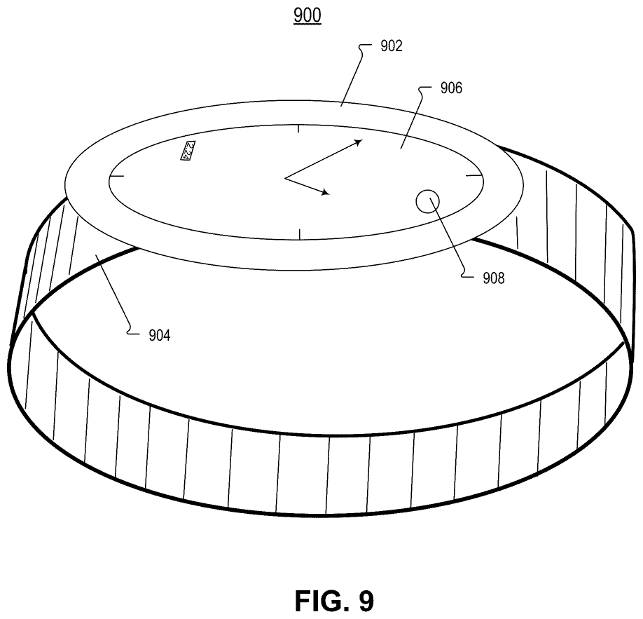

FIG. 9 illustrates a diagram of a smart watch 900 as an example of a wearable device that may be configured to use a color perception model to maintain consistency of color perception of image data over a range of ambient light intensities, in accordance with aspects of the disclosure. Smart watch 900 may include a body 902 coupled to a band 904. Body 902 may include a display 906 and a camera 908. Smart watch 900 may include processing logic 910 that is carried within body 902. Camera 908 may capture ambient light intensity data and provide the ambient light intensity data to processing logic 910. Processing logic 910 may be configured to apply a color perception model (e.g., color perception model 102 of FIG. 1) to image data to maintain consistency of color perception for image data displayed on display 906 over a variety of ambient light intensities, according to an embodiment.

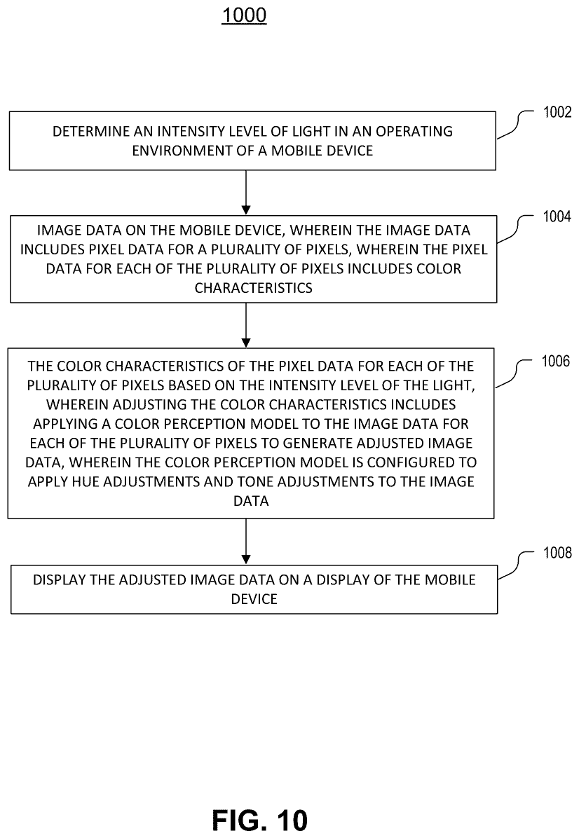

FIG. 10 illustrates a flow diagram of a process 1000 for adjusting image data to maintain color perception of the image data over various ambient light intensities, in accordance with aspects of the disclosure. The order in which some or all of the process blocks appear in process 1000 should not be deemed limiting. Rather, one of ordinary skill in the art having the benefit of the present disclosure will understand that some of the process blocks may be executed in a variety of orders not illustrated, or even in parallel.

In process block 1002, process 1000 may include determining an intensity level of light in an operating environment of a mobile device, according to an embodiment.

In process block 1004, process 1000 may include storing image data on the mobile device, wherein the image data includes pixel data for a plurality of pixels, according to an embodiment. The pixel data for each of the plurality of pixels includes color characteristics, according to an embodiment.

In process block 1006, process 1000 may include adjusting the color characteristics of the pixel data for each of the plurality of pixels based on the intensity level of the light, according to an embodiment. Adjusting the color characteristics includes applying a color perception model to the image data for each of the plurality of pixels to generate adjusted image data, according to an embodiment. The color perception model is configured to apply hue adjustments and tone adjustments to the image data, according to an embodiment.

In process block 1008, process 1000 may include displaying the adjusted image data on a display of the mobile device, according to an embodiment.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The term “processing logic” (e.g., 118) in this disclosure may include one or more processors, microprocessors, multi-core processors, Application-specific integrated circuits (ASIC), and/or Field Programmable Gate Arrays (FPGAs) to execute operations disclosed herein. In some embodiments, memories (not illustrated) are integrated into the processing logic to store instructions to execute operations and/or store data. Processing logic may also include analog or digital circuitry to perform the operations in accordance with embodiments of the disclosure.

A “memory” or “memories” (e.g., 112) described in this disclosure may include one or more volatile or non-volatile memory architectures. The “memory” or “memories” may be removable and non-removable media implemented in any method or technology for storage of information such as computer-readable instructions, data structures, program modules, or other data. Example memory technologies may include RAM, ROM, EEPROM, flash memory, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device.

A network may include any network or network system such as, but not limited to, the following: a peer-to-peer network; a Local Area Network (LAN); a Wide Area Network (WAN); a public network, such as the Internet; a private network; a cellular network; a wireless network; a wired network; a wireless and wired combination network; and a satellite network.

Communication channels may include or be routed through one or more wired or wireless communication utilizing IEEE 802.11 protocols, short-range wireless protocols, SPI (Serial Peripheral Interface), I²C (Inter-Integrated Circuit), USB (Universal Serial Port), CAN (Controller Area Network), cellular data protocols (e.g. 3G, 4G, LTE, 5G), optical communication networks, Internet Service Providers (ISPs), a peer-to-peer network, a Local Area Network (LAN), a Wide Area Network (WAN), a public network (e.g. “the Internet”), a private network, a satellite network, or otherwise.

A computing device may include a desktop computer, a laptop computer, a tablet, a phablet, a smartphone, a feature phone, a server computer, or otherwise. A server computer may be located remotely in a data center or be stored locally.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible non-transitory machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A method comprising:
determining an intensity level of light in an operating environment of a mobile device;
storing image data on the mobile device, wherein the image data includes pixel data for a plurality of pixels, wherein the pixel data for each of the plurality of pixels includes color characteristics;
adjusting the color characteristics of the pixel data for each of the plurality of pixels based on the intensity level of the light, wherein adjusting the color characteristics includes applying a color perception model to the image data for each of the plurality of pixels to generate adjusted image data, wherein the color perception model is configured to adjust hue color characteristics and tone color characteristics of the image data; and
displaying the adjusted image data on a display of the mobile device.

2. The method of claim 1, wherein the color perception model includes a plurality of 3×3 matrices, wherein each 3×3 matrix of the plurality of 3×3 matrices is configured to tune the hue color characteristics of the image data based on the intensity level of light.

3. The method of claim 2, further comprising:
selecting one of the plurality of 3×3 matrices based on intensity level of light; and
applying the selected one of the plurality of 3×3 matrices to the pixel data for each of the plurality of pixels.

4. The method of claim 1, wherein the color perception model includes a plurality of tone settings, wherein each of the plurality of tone settings is paired with a corresponding one of a plurality of ranges for the intensity level of light.

5. The method of claim 1, wherein the color perception model includes a plurality of brightness settings, wherein each of the plurality of brightness settings is paired with a corresponding one of a plurality of ranges for the intensity level of light.

6. The method of claim 1, wherein the color perception model includes a look up table (LUT) that determines a hue adjustment matrix and a tone setting for application to the image data based on a range of values for the intensity level of light of the operating environment of the mobile device.

7. The method of claim 6, wherein the LUT includes brightness settings for the display of the mobile device, wherein the brightness settings are determined from a brightness model, wherein the brightness model is trained on an image data set that is hue adjusted and tone adjusted for color perception consistency.

8. The method of claim 1, wherein the pixel data for each of the plurality of pixels includes a red value (R), a green value (G), and a blue value (B).

9. The method of claim 1, wherein determining the intensity level of light includes at least one of:
analyzing the image data to estimate the intensity level of light; or
reading ambient light intensity from a light detector coupled to the mobile device.

10. The method of claim 1, further comprising:
receiving the image data from a camera coupled to the mobile device;
receiving the image data from a wireless communications device of the mobile device; or
receiving the image data from a wired connection to the mobile device.

11. The method of claim 1, wherein the mobile device is a smart watch or a head-mounted device.

12. The method of claim 1, wherein the color perception model includes a hue model and a tone model, wherein the hue model includes settings for the hue color characteristics, wherein each of the settings for the hue color characteristics includes one of a plurality of 3×3 matrices, wherein each of the plurality of 3×3 matrices is associated with a corresponding one of a plurality of ambient light ranges.

13. The method of claim 12, wherein the tone model includes a plurality of settings for the tone color characteristics, wherein each of the plurality of settings for the tone color characteristics is associated with a corresponding one of the plurality of ambient light ranges.

14. A wearable mobile device comprising:
a display configured to display adjusted image data;
memory storing instructions; and
processing logic coupled to the memory, wherein the processing logic is configured to execute the instructions to perform a process that includes:
determine an ambient light intensity for a wearable mobile device;
receive image data having a plurality of pixels, wherein each of the plurality of pixels in the image data includes color characteristics;
tune the color characteristics of the plurality of pixels with a color perception model that is based on the ambient light intensity to generate the adjusted image data, wherein the color perception model is configured to tune hue color characteristics and tone color characteristics to reduce perceptual inconsistencies in colors of image data across a range of ambient light intensities; and
display the adjusted image data on the display.

15. The wearable mobile device of claim 14, wherein the color perception model includes a hue model configured to tune the hue color characteristics, wherein the color perception model includes a tone model configured to tune the tone color characteristics, wherein the hue model includes a plurality of 3×3 matrices, wherein each of the plurality of 3×3 matrices is paired with a corresponding one of a plurality of ranges of ambient light intensity.

16. The wearable mobile device of claim 15, wherein the hue model is trained using a pseudo-inverse method that is trained on a data set of observer perception data.

17. A wearable mobile device comprising:
a display configured to display adjusted image data;
memory storing instructions; and
processing logic coupled to the memory and configured to execute the instructions, wherein the instructions include:
a color perception module configured to generate the adjusted image based on image data and based on a plurality of ranges of ambient light intensity, wherein the adjusted image data is modified by the color perception module to improve perceptual consistency of color in the image data across the plurality of ranges of ambient light intensity, wherein the color perception module includes:
a hue module configured to apply one of a plurality of 3×3 matrices to the image data based on one of the plurality of ranges of ambient light intensity; and
a tone module configured to apply one of a plurality of tone settings to the image data.

18. The wearable mobile device of claim 17, wherein each 3×3 matrix of the plurality of 3×3 matrices is configured to tune hue color characteristics of the image data, wherein each of the plurality of 3×3 matrices is paired with a corresponding one of the plurality of ranges of ambient light intensity.

19. The wearable mobile device of claim 17, wherein the wearable mobile device is a smart watch or a head-mounted device.

20. The wearable mobile device of claim 17, wherein the color perception module includes a look up table (LUT) that includes plurality of ranges of ambient light intensity, wherein the plurality of ranges are paired with a corresponding one of a plurality of tone settings, wherein the plurality of ranges are paired with a corresponding one of a plurality of screen brightness settings.
